(19) United States
(12) Patent Application Publication
(10) Pub. No.: US 2018/0170548 A1
(43) Pub. Date: Jun. 21, 2018

(54) AIRCRAFT MODULE COVERING DEVICE

(71) Applicant: RECARO Aircraft Seating GmbH & Co. KG, Schwaebisch Hall (DE)

(72) Inventors: Eugen WOHLMANN, Pfedelbach-Oberohrn (DE); Dennis GIESWEIN, Heilbronn (DE); Adam WOJSIAT, Schwaebisch Hall (DE); Marius HAGEMANN, Schwaebisch Hall (DE); Philip GRAESER, Schwaebisch Hall (DE)

(21) Appl. No.: 15/565,943

(22) PCT Filed: Apr. 8, 2016
(86) PCT No.: PCT/EP2016/057762

§ 371 Date: Feb. 27, 2018

(30) Foreign Application Priority Data
Apr. 13, 2015 (DE) 10 2015 105 619.4

(51) Int. Cl. B64D 11/06; F16B 2/24; F16B 5/06; F16B 5/12; F16B 21/07

(52) U.S. Cl. CPC B64D 11/0606; F16B 2/245; F16B 21/075; F16B 5/125; F16B 5/065

(57) ABSTRACT

An aircraft module covering device includes at least one aircraft module and with at least one panel which is configured for covering the aircraft module and is for this purpose fixedly connected to the aircraft module to at least partly cover the aircraft module in a mounted state, wherein the panel is configured to be connected to the aircraft module via at least one form-fit connection and comprises for this purpose at least one connection element, which is fixedly arranged on an underside of the panel.

### STATE OF THE ART

The invention relates to an aircraft module covering device according to the preamble of claim 1.

An aircraft module covering device with at least one aircraft module and with at least one panel, which is configured for covering the aircraft module and is for this purpose fixedly connected to the aircraft module to at least partly cover the aircraft module in a mounted state, has already been proposed.

The objective of the invention is in particular to provide a generic device with improved characteristics regarding assembly and exchangeability. The objective is achieved, according to the invention, by the features of patent claim 1 while advantageous implementations and further developments of the invention will become apparent from the subclaims.

### Advantages of the Invention

The invention is based on an aircraft module covering device with at least one aircraft module and with at least one panel which is configured for covering the aircraft module and is for this purpose fixedly connected to the aircraft module to at least partly cover the aircraft module in a mounted state.

It is proposed that the panel is configured to be connected to the aircraft module via at least one form-fit connection and comprises for this purpose at least one connection element, which is fixedly arranged on an underside of the panel. An “aircraft module” is herein in particular to mean a structural component within an aircraft cabin, in particular a structural component of a flight passenger seat unit. An aircraft module is herein, for example, implemented as a depositing console of a flight passenger seat unit, as a handrail, as a bumper strip or as a closing strip. Principally it is also conceivable that the aircraft module is embodied as a different structural component of a flight passenger seat unit, which is to be covered by a panel. A “panel” is herein in particular to mean a thin-walled structural component. Preferably a panel is herein embodied as a planar component. Principally it is however also conceivable that the panel is embodied as a narrow thin-walled strip or as a thin-walled profile element. A panel is herein preferentially embodied as a covering element and is configured to cover an aircraft module for the purpose of creating an agreeable optical impression. The panel may also be configured to protect the aircraft module that is to be covered from damaging. By “the panel being connected to the aircraft module” is herein in particular to be understood that the panel is captively attached to the aircraft module but is also separable from the aircraft module by applying a disassembly force. By “the panel at least partly covering the aircraft module” is herein in particular to be understood that the panel covers at least a portion, preferably a large portion, of the aircraft module and, in an especially advantageous implementation, covers the entire aircraft module. By a “connection element” is herein in particular an element to be understood which is configured to generate, in a form-fit and/or force-fit fashion, preferably in a force-fit fashion, i.e. in particular via friction, a connection to a correspondingly embodied element, like in particular a connecting element, which connection is fix at least up to a certain disassembly force. By an “underside of the panel” is herein in particular a side of the panel to be understood which in a mounted state faces towards the aircraft module that is covered by the panel. The underside is implemented as the side situated opposite the visible side of the panel. By a “visible side of the panel” is herein in particular a side of the panel to be understood which in a mounted state faces outwards and is visible to a passenger of the aircraft cabin. “Configured” is in particular to mean specifically designed and/or equipped. By an object being configured for a certain function is in particular to be understood that the object fulfills and/or implements said certain function in at least one application state and/or operating state. An implementation according to the invention allows providing an advantageous aircraft module covering device, the aircraft modules of which may be covered by a panel in a simple and quick manner, wherein the panels are in particular easy to mount and are in particular separable from the one corresponding aircraft module in an advantageously simple manner.

It is further proposed that the at least one connection element on the underside of the panel is implemented as an extension. By “the connection element being implemented as an extension” is herein in particular to be understood that the connection element extends from the underside in a direction away from the visible side of the panel, wherein the extension implemented by the connection element features at least twice a wall thickness of the panel and preferably has an extent of at least 5 mm, in a particularly advantageous implementation at least 10 mm. In this way the at least one connection element is implementable in an especially simple and advantageous fashion.

Furthermore it is proposed that the panel is configured to be connected to the aircraft module in such a way that it is non-destructively releasable. “Non-destructively releasable” is herein in particular to mean that, starting from a state in which the panel is captively mounted on the aircraft module, the panel is demountable from the aircraft module without damages to elements involved in a connection between the panel and the aircraft module and without damages to the panel or to the aircraft module. This allows advantageously simple and quick disassembly of the panel and later on, if required, re-mounting of the panel to the aircraft module.

It is also proposed that the at least one connection element on the underside of the panel is implemented as a flat gudgeon. By a “flat gudgeon” is herein in particular an extension to be understood which has, in an extension direction orthogonal to the underside of the panel, a preferably rectangular cross-section, wherein first side edges are embodied significantly longer than second side edges. It is herein possible that different connection elements of a panel have different cross-sections, lengths and/or shapes. A cross-section, and thus a thickness, as well as a width of a connection element and a length of the connection element may be influenced by structural conditions and by materials of the elements which are to be connected. It is herein also conceivable that a connection element embodied as a gudgeon features, for example, a wave form or has a width that changes along its length. Principally it is also conceivable that a connection element additionally comprises a form-fit element, e.g. a latch element. This allows implementing the at least one connection element in an especially advantageous manner.

Beyond this it is proposed that the at least one connection element is connected to the panel by substance-to-substance bond. “Connected by substance-to-substance bond” is herein in particular to mean connected to each other via a material bond, like in particular an adhesive bond, a welding bond or any other material bond that is deemed expedient by someone skilled in the art. Principally a connection by substance-to-substance bond is also to mean an integral implementation of the elements which are connected to each other by substance-to-substance bond. In this way the at least one connection element is connectable to the panel in an especially simple fashion.

It is moreover proposed that the at least one connection element is connected to the panel via an adhesive bond. An “adhesive bond” is herein in particular to mean a connection of at least two elements via adhesive forces, wherein the elements are connected to one another by an adhesive material. This allows achieving an especially simple and secure connection of the at least one connection element to the panel.

Furthermore it is proposed that the panel is embodied as a deep-drawn plastic component. This allows implementing the panel in a particularly simple and advantageous manner.

It is also proposed that the aircraft module covering device comprises at least one connecting element, which is configured for captively connecting the at least one connection element of the panel to the aircraft module in at least one operating state. By a “connecting element” is herein in particular an element to be understood which is configured to generate, via a force-fit and/or form-fit connection, a captive connection between the connection element of the panel and the connecting element. Herein the connecting element is preferentially embodied as a clamping element, which is configured to exert a clamp force, wherein the connecting element is in particular configured to establish, by the clamp force, a friction-fit connection between the connecting element and the connection element of the panel for the purpose of connecting the connecting element to the connection element. Principally it is also conceivable that the connecting element is embodied as a differently implemented force-fit and/or form-fit element. It is herein conceivable that the connecting element comprises, for example, a friction element, a latch element or other elements configured for a force-fit and/or form-fit connection. A “captive connection” is herein in particular to mean that in a normal state, in which no forces greater than a normal load act on the panel, the panel is securely connected to the aircraft module and is not inadvertently releasable therefrom. In this way a particularly simple connection between the panel and the aircraft module is achievable.

It is further proposed that, for captively connecting the connection element of the panel to the aircraft module, the at least one connecting element is implemented separately. By “the connecting element being implemented separately” is herein in particular to be understood that the connecting element is embodied as an individual element and is in particular embodied apart from the panel and/or from the aircraft module. A connection between the connecting element and the panel and/or the aircraft module is created by a force-fit and/or form-fit connection. This allows implementing the connecting element in an especially advantageous manner.

In addition it is proposed that the aircraft module comprises at least one recess in which the at least one connecting element, which is embodied separately, engages in a mounted state. A “recess” is herein in particular to mean a through hole or a blind hole. In this way a particularly simple accommodation for the connecting element may be made available, via which the connecting element is connectable to the aircraft module.

It is moreover proposed that the connecting element has a U-shaped basis shape, implementing at least two inward-oriented hook elements. By a “hook element” is herein in particular an element to be understood which is oriented counter to a mounting direction of a connection element that is connected to the connecting element, and which is in particular configured to generate, in a deflecting movement, a reset force acting counter to the connection element that is connected to the connecting element, the reset force thus increasing a friction force between the connecting element and the connection element. Principally it is also conceivable that the connecting element has a different basis shape, which is preferentially similar to a U-shape. This allows implementing the connecting element especially advantageously for connecting the panel to the aircraft module via the connection element.

Furthermore it is proposed that the connecting element is configured to be coupled with an aircraft module that is made of sheet metal. In this way aircraft modules made of sheet metal are coverable with a panel via the connection to the connecting element in a particularly advantageous manner.

It is further proposed that the connecting element is configured to be coupled with an aircraft module that is made of a fiber-composite material. In this way aircraft modules made of a fiber-composite material are especially advantageously coverable with a panel via the connection to the connecting element.

It is moreover proposed that the at least one connection element is embodied always in the same fashion, independently from a material of an aircraft module that is to be covered. This allows implementing a panel independently from a material of the aircraft module that is to be covered.

The aircraft module covering device according to the invention is herein not to be limited to the application and implementation described above. In particular, to fulfill a functionality herein described, the aircraft module covering device according to the invention may comprise a respective number of individual elements, structural components and units that differs from a number that is mentioned herein.

### DRAWINGS

Further advantages may be gathered from the following description of the drawings. In the drawings an exemplary embodiment of the invention is represented. The drawings, the description and the claims contain a plurality of features in combination. Someone skilled in the art will purposefully also consider the features separately and will find further expedient combinations.

It is shown in:

FIG. 1 a schematic representation of an aircraft module covering device according to the invention, with a flight passenger seat module,

FIG. 2 a schematic detail view of a panel of the aircraft module covering device,

FIG. 3 a schematic detail view of an aircraft module and a connecting element of the aircraft module covering device,

FIG. 4 a schematic sectional view of a connection of the aircraft module to the panel via a connecting element,

FIG. 5 a schematic representation of a further aircraft module that is made of a fiber-composite material,

FIG. 6 a schematic detail view of the aircraft module that is made of a fiber-composite material and a connecting element, and

FIG. 7 a schematic sectional view of a connection of the aircraft module that is made of a fiber-composite material to the panel via a connecting element.

### DESCRIPTION OF THE EXEMPLARY EMBODIMENT

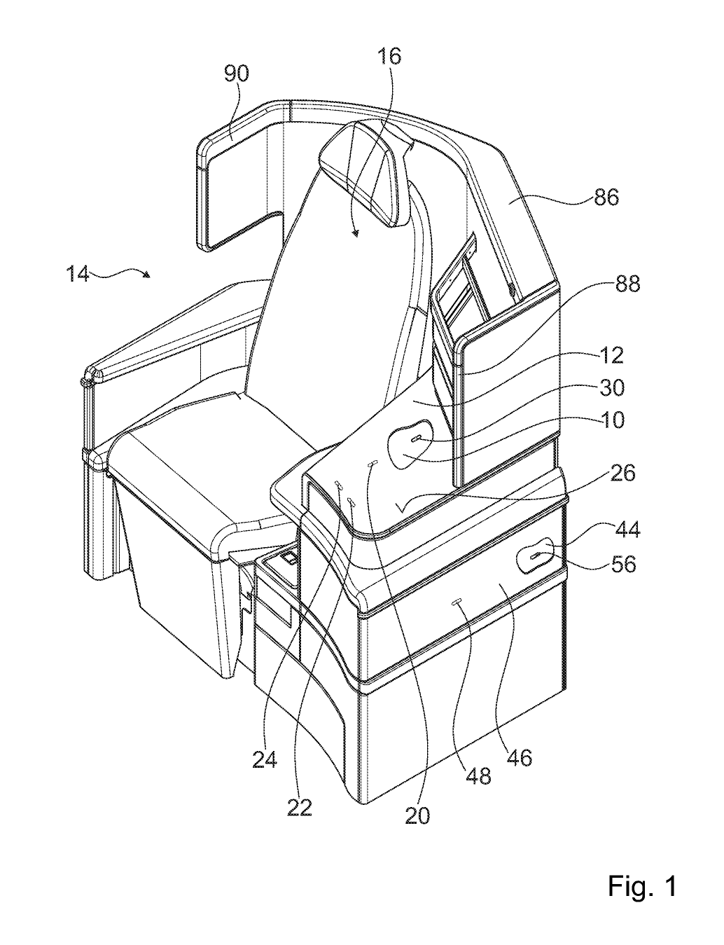

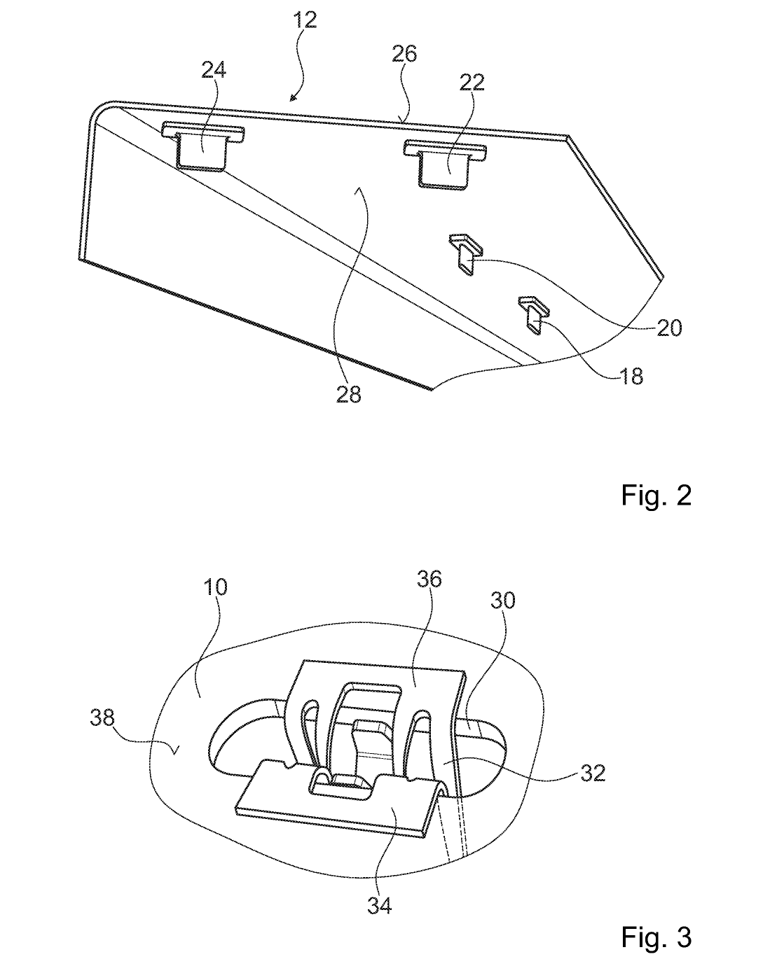

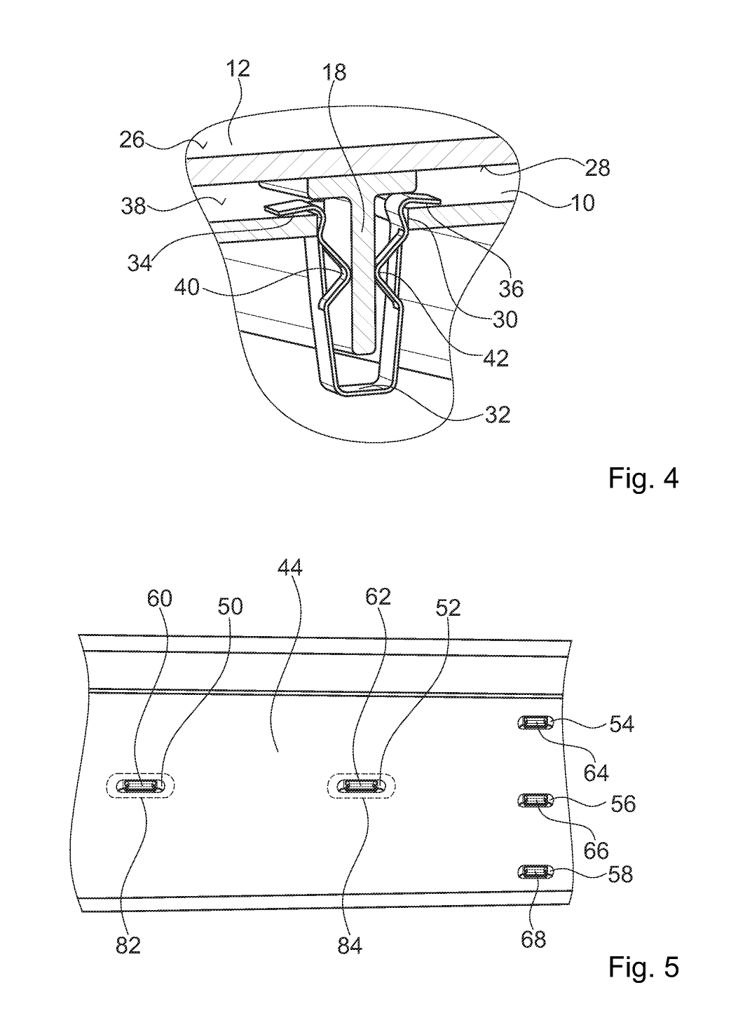

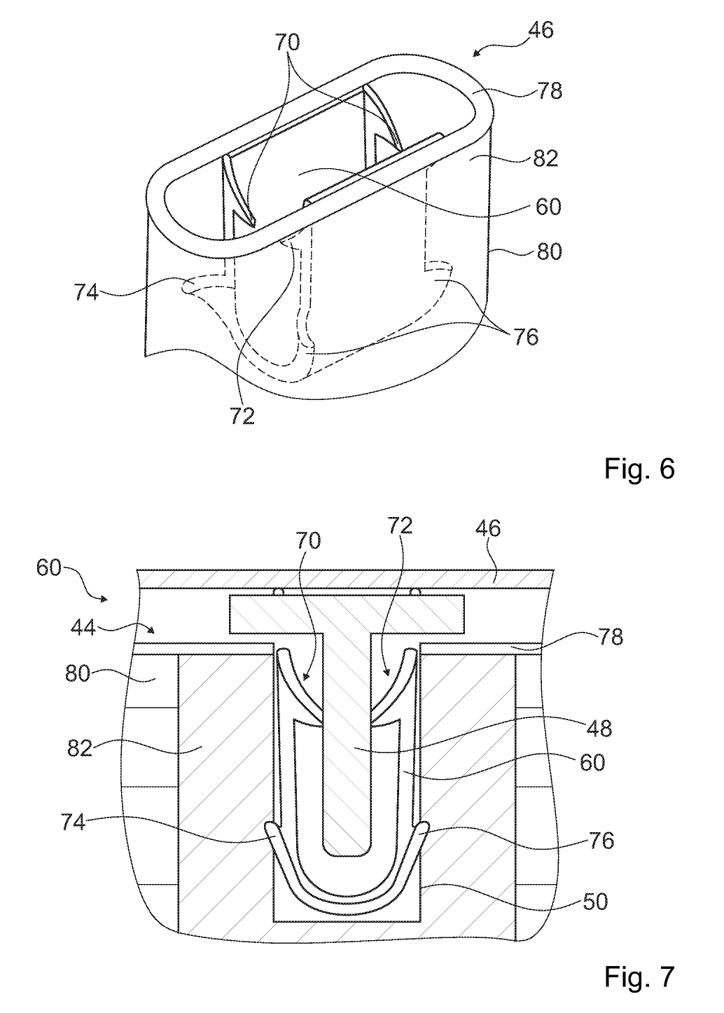

FIGS. 1 to 7 show an aircraft module covering device according to the invention. The aircraft module covering device is part of an aircraft cabin. The aircraft cabin comprises a flight passenger seat module 14. The aircraft module covering device is implemented as a portion of the flight passenger seat module 14. The flight passenger seat module 14 comprises a flight passenger seat 16, which is configured to allow a passenger to sit on it. The flight passenger seat module 14 implements a seat area for a passenger in which, in addition to the flight passenger seat 16, further elements intended for the passenger are arranged, like for example stowage or depositing facilities. The aircraft module covering device comprises a first aircraft module 10. The aircraft module 10 is embodied as part of the flight passenger seat module 14. The aircraft module 10 forms a portion of a console, which is arranged next to the flight passenger seat 16 and is configured to provide a depositing area which a passenger sitting on the flight passenger seat 16 may deposit objects on. The aircraft module 10 is embodied as a structural component of the flight passenger seat module 14. The aircraft module 10 herein implements a portion of a load-bearing structure of the flight passenger seat module 14. The aircraft module 10 is implemented of sheet metal. The aircraft module 10 is herein embodied as a bent sheet-metal part.

Principally it is also conceivable that the aircraft module is implemented as a different structural component of a flight passenger seat module, e.g. as part of the flight passenger seat 16 like, for example, as a portion of a backrest, or of a different structural component of the flight passenger seat 16 deemed expedient by someone skilled in the art, or as part of a shell of the flight passenger seat module 14. Principally it is also conceivable that the aircraft module is embodied as part of an aircraft cabin, for example as a wall in a region of an aircraft toilet or of an on-board kitchen. It is principally also conceivable that the aircraft module forms at least part of a luggage compartment of the aircraft cabin.

The aircraft module covering device comprises a panel 12. The panel 12 is embodied as a thin planar structural component. Herein the panel 12 is embodied as a deep-drawn plastic component. The panel 12 herein has a shape implemented correspondingly to a shape of the aircraft module 10. The panel 12 is configured to entirely cover the aircraft module 10 in a mounted state. It is principally also conceivable that the panel 12 is merely configured to partly cover the aircraft module 10, wherein a remaining portion of the aircraft module 10 may be continue without a covering or is covered by another panel. The panel 12 has a visible side 26, which faces away from the aircraft module 10, which is covered by the panel 12. The visible side 26 faces towards an interior space of the aircraft cabin, thus implementing the surface which is perceived and may be touched by passengers. Taking account of this, the panel 12 has on its visible side 26 a surface which is implemented esthetically agreeable as well as resistant against damage.

The panel 12 is in a mounted state captively connected to the aircraft module 10 in a fixed fashion. The panel 12 is configured to be connected to the aircraft module 10 via at least one force-fit connection. For a force-fit connection to the aircraft module 10, the panel 12 comprises a plurality of connection elements 18, 20, 22, 24. The connection elements 18, 20, 22, 24 are fixedly arranged on an underside 28 of the panel 12. The underside 28 of the panel 12 is situated opposite the visible side 26 of the panel 12. In a mounted state the underside 28 of the panel 12 faces toward the aircraft module 10 which is covered by the panel 12. The connection elements 18, 20, 22, 24 are embodied as extensions which extend away from the underside 28. The connection elements 18, 20, 22, 24 on the underside of the panel 12 are embodied as flat gudgeons. Herein all of the connection elements 18, 20, 22, 24 may be embodied identically. Principally it is conceivable that the different connection elements 18, 20, 22, 24 which are connected to the panel 12 feature different cross-sections and/or lengths, in accordance with structural conditions and/or material combinations. The connection elements 18, 20, 22, 24 are fixedly connected to the underside 28 of the panel 12 in a captive fashion. The connection elements 18, 20, 22, 24 are connected to the underside 28 of the panel 12 by substance-to-substance bond. The connection elements 18, 20, 22, 24 are respectively connected to the underside 28 of the panel 12 via an adhesive bond. For this purpose, in a manufacturing procedure of the panel 12 an adhesive means is arranged between the underside 28 of the panel 12 and a gluing surface of the connection elements 18, 20, 22, 24, which respectively connects the connection elements 18, 20, 22, 24 to the panel 12 by substance-to-substance bond. To create a defined bonding gap between the underside 28 of the panel 12 and the gluing surface of the connection elements 18, 20, 22, 24, the connection elements 18, 20, 22, 24 have a plurality of little bumps (not shown) on their gluing surfaces. By the bumps the bonding gap between the respective connection element 18, 20, 22, 24 and the underside 28 of the panel 12 is defined, which is filled with the adhesive means for the purpose of the connection. The defined bonding gap allows keeping to advantageously small manufacturing tolerances and allows achieving an especially advantageous gluing between the panel 12 and the respective connection element 18, 20, 22, 24. In a manufacturing procedure for connecting the connection elements 18, 20, 22, 24 on the underside 28 of the panel 12, the connection elements 18, 20, 22, 24 are placed by means of a template laid upon the panel 12, and are then glued on. For this purpose the template having corresponding recesses for the connection elements 18, 20, 22, 24 is placed on the underside 28 of the panel 12 in a defined manner. In the given recesses the connection elements 18, 20, 22, 24 are connected to the underside 28 of the panel 12 accordingly via a defined gluing layer of the adhesive means. It is principally also conceivable that the connection elements 18, 20, 22, 24 are fixedly glued with the panel 12 via robot-controlled placement. The panel 12 is in such a case fixedly clamped in a holder in a defined basic position, and computer-controlled robots glue the connection elements 18, 20, 22, 24 to the panel 12 precisely positioning them in the respective points of the underside 28 of the panel 12. Principally it would also be conceivable that the connection elements 18, 20, 22, 24 are fixedly connected to the panel 12 in a different manner that is deemed expedient by someone skilled in the art, for example via a form-fit connection.

For the purpose of connecting the panel 12 to the aircraft module 10, the aircraft module 10 comprises a recess 30 for each connection element 18, 20, 22, 24 of the panel 12. The recesses 30 are implemented as through-holes introduced in the aircraft module 10 that is made of sheet metal. The recesses 30 are implemented as form-fit elements. For connecting the panel 12 to the aircraft module 10, the aircraft module covering device comprises a connecting element 32 for each connection element 18, 20, 22, 24. The connecting elements 32 are configured to be arranged, in a mounted state, in a recess 30 of the aircraft module 10 and to accommodate a corresponding connection element 18, 20, 22, 24 of the panel 12. The connecting elements 32 are herein respectively embodied as separate structural components. Each connecting element 32 is in itself embodied as an individual separate structural component.

In the following only the one connecting element 32 as well as a connection of the connecting element 32 to the connection element 18 and to the recess 30 will be described in detail. A connection of the panel 12 to the aircraft module 10 via the further pairings of respective connection element 18, 20, 22, 24, connecting element 32 and corresponding recess in the aircraft module 10 is established accordingly. The connecting element 32 is embodied as a bent sheet metal part. Principally it is also conceivable that the connecting element 32 is made of a different material deemed expedient by someone skilled in the art. The connecting element 32 has a U-shaped basis form. In a region in which the connecting element 32 is implemented U-shaped in its cross-section, the connecting element 32 comprises two side walls having a distance from one another which is smaller than a width of the recess 30 of the aircraft module 10, in which the connecting element 32 is arranged in a mounted state. On its upper, open side the connecting element 32 comprises on its two ends respective support elements 34, 36, which are respectively bent by 90 degrees. The support elements 34, 36 are configured to support themselves in a mounted state on an upper side 38 of the aircraft module 10. The connecting element 32 comprises two inward-oriented hook elements 40, 42. The hook elements 40, 42 are situated opposite one another and extend towards one another. Each hook element 40, 42 is respectively implemented by a side wall of the connecting element 32. In a load-free state the two hook elements 40, 42 have a minimum distance from one another, which is smaller than a thickness of the connection element 18. The hook elements 40, 42 are implemented elastically deformable. To connect the connecting element 32 to the connection element 18, the connection element 18 is slid between the two hook elements 40, 42. As the connection element 18 is thicker than a distance between the two hook elements 40, 42 in a load-free state, the hook elements 40, 42 are deflected outwards. Due to being elastically deflected, the hook elements 40, 42 generate a counterforce oriented towards the connection element 18 which is arranged between the hook elements 40, 42. By this counterforce a stiction is generated between the connection element 18 and the hook elements 40, 42 of the connecting element 32. By the deflection of the hook elements 40, 42 the side walls of the connecting element 32 are also pushed outwards, as a result of which the connecting element 32 is jammed in the recess 30 of the aircraft module 10. By inserting the connection element 18 between the hook elements 40, 42 of the connecting element 32, the connection element 18 is connected to the connecting element 32 in a force-fit fashion and at the same time the connecting element 32 is jammed in the recess 30 of the aircraft module 10. As a result, the connection element 18 is connected to the aircraft module 10 via the connecting element 32 in a fixed and captive manner. By means of the connection via the connection element 18 and the connecting element 32 as well as the further connection elements 20, 22, 24 of the panel 12 and the further connecting elements, it is possible to connect the panel 12 to the aircraft module 10, i.e. in particular to the recesses 30 of the aircraft module 10, without damages. Moreover, when the panel 12 is demounted from the aircraft module 10, no further components, like for example a double-faced adhesive tape, screws or the like need to be removed. Applying a disassembly force to the panel 12, respectively to the corresponding connection elements 18, 20, 22, 24, said disassembly force being oriented counter to a mounting direction in which the connection elements 18, 20, 22, 24 are inserted into the corresponding connecting elements 32, allows releasing the connection elements 18, 20, 22, 24 from the respective connecting elements 32. The disassembly force is herein greater than a clamping force respectively acting from the connecting elements 32 onto the connection elements 18, 20, 22, 24. The disassembly force is herein equivalent to 15 Newton for each of the connection elements 18, 20, 22, 24 respectively. Herein a total disassembly force results from the respective disassembly forces of all connection elements 18, 20, 22, 24. In disassembly the connection elements 18, 20, 22, 24 slide out of the corresponding connecting elements 32 in the demounting direction, wherein neither the connection elements 18, 20, 22, 24 nor the connecting elements 32 nor the aircraft module 10 are damaged or destroyed. Herein no further elements need to be removed from the aircraft module 10 or the panel 12 in disassembly. For disassembly purposes, the panel 12 features markings (not shown in detail) showing points of application to an assembly operator, in which he may apply the disassembly force to the panel 12 for secure disassembly. A mounting of the panel 12 to the aircraft module 10 is possible with the same connecting elements 32 and connection elements 18, 20, 22, 24. Principally it is also conceivable that the points of application are only indicated in a manual for the assembly operator.

The aircraft module covering device comprises a further aircraft module 44. The aircraft module 44 is embodied as part of the flight passenger seat module 14. The aircraft module 44 forms part of a shell of the flight passenger seat module 14. The aircraft module 44 implements a side wall of the flight passenger seat module 14. The aircraft module 44 is implemented of a fiber-composite plate 78 and a stiffening structure 80 which is connected to the fiber-composite plate 78. Herein an outward-facing side is formed by the fiber-composite plate 78 and the stiffening structure 80 is fixedly connected to the fiber-composite plate 78 on an inner side. The stiffening structure 80 is herein embodied as a honeycomb structure. Principally it is also conceivable that the stiffening structure 80 is embodied as a different structure deemed expedient by someone skilled in the art, like for example as a phenolic resin or as a foam.

The aircraft module covering device comprises a panel 46, which is configured to cover the aircraft module 44, which is implemented of a fiber-composite material, in a mounted state. The panel 46 covers the aircraft module 44 in the mounted state. For a connection to the aircraft module 44, the panel 46 comprises a plurality of connection elements 48. Like the panel 12, the panel 46 is implemented as a thin planar structural component. Herein the panel 46 is also embodied as deep-drawn plastic component. The panel 46 herein has a shape implemented correspondingly to a shape of the aircraft module 44. The connection elements 48 are embodied identically to the connection elements 18, 20, 22, 24 of the panel 12 and are connected to the panel 46 in the same way. The connection elements 18, 20, 22, 24, 48 are embodied always in the same manner, independently from a material of the aircraft module 10, 44 that is to be covered.

For a connection of the panel 46 via the connection elements 48, the aircraft module 44 comprises respectively one recess 50, 52, 54, 56, 58 for each connection element 48 of the panel 46. The recesses 50, 52, 54, 56, 58 are herein implemented as blind holes and are introduced into the fiber-composite plate 78 and the stiffening structure 80 of the aircraft module 44. The recesses 50, 52, 54, 56, 58 herein have a rectangular basis shape with rounded lateral edges. In the regions of the recesses 50, 52, 54, 56, 58, the panel 46 has reinforcement zones 82, 84. In the reinforcement zones 82, 84 the stiffening structure 80, which is embodied as a honeycomb structure, is filled with a reinforcement material for the purpose of reinforcement. The reinforcement material is herein implemented as a filling material. The reinforcement material is herein embodied as a resin, in particular as a phenolic resin. The reinforcement zones 82, 84 are herein larger than the recesses 50, 52, 54, 56, 58. The reinforcement zones 82, 84 herein respectively encompass the recesses 50, 52, 54, 56, 58 which they are allocated to. For the purpose of connecting the panel 46 to the aircraft module 44, the aircraft module covering device comprises a connecting element 60, 62, 64, 66, 68 for each connection element 48. The connecting elements 60, 62, 64, 66, 68 are configured to be in a mounted state arranged in one of the recesses 50, 52, 54, 56, 58 of the aircraft module 44 and to accommodate a respective connection element 48 of the panel 46. The connecting elements 60, 62, 64, 66, 68 are herein respectively embodied as separate structural components. Each connecting element 60, 62, 64, 66, 68 is in itself implemented as an individual, separate structural component. The connecting elements 60, 62, 64, 66, 68 are configured for being coupled to an aircraft module 44 that is made of a fiber-composite material.

In the following only the one connecting element 60 as well as a connection of the connecting element 60 to the connection element 48 and the recess 50 will be described in detail. Connections of the panel 46 to the aircraft module 44 via the further pairings of respective connection element 48, connecting element 62, 64, 66, 68 and corresponding recess 52, 54, 56, 58 in the aircraft module 44 are established accordingly. The connecting element 60 is embodied as a bent sheet metal part. Principally it is also conceivable that the connecting element 60 is embodied of a different material which is deemed expedient by someone skilled in the art. The connecting element 60 has a U-shaped basis shape. In the region in which the connecting element 60 is embodied U-shaped in a cross-section, the connecting element 60 comprises two side walls having a distance from one another which is smaller than a width of the recess 50 of the aircraft module 44, in which the connecting element 60 is arranged in a mounted state. The connecting element 60 comprises two inward-oriented hook elements 70, 72. The hook elements 70, 72 are situated opposite one another and extend towards one another. Each hook element 70, 72 is respectively implemented by a side wall of the connecting element 60. In a load-free state the two hook elements 70, 72 have a minimum distance from one another which is smaller than a thickness of the connection element 48. The hook elements 70, 72 are embodied elastically deformable. For the purpose of connecting the connecting element 60 to the connection element 48, the connection element 48 is slid between the two hook elements 70, 72. As the connection element 48 is thicker than a distance between the two hook elements 70, 72 in a load-free state, the hook elements 70, 72 are deflected outwards. On its lower end the connecting element 60 comprises two outward-oriented hook elements 74, 76, which are configured for a connection of the connecting element 60 to the aircraft module 44. When during mounting the connection element 48 is introduced between the inward-oriented hook elements 70, 72, the outward-oriented hook elements 74, 76 are pushed away outwards and are thus pushed into the reinforcement zone 82 of the aircraft module 44. As a result of this, the connecting element 60 is connected in the recess 50 via the outward-oriented hook elements 74, 76 in a form-fit fashion, and is thus arranged in the recess 50 in a captive fashion when the connection element 48 pushes the hook elements 70, 72, 74, 76 outwards.

Applying a disassembly force directed counter to a mounting direction, in which the connection elements 48 are respectively introduced in the corresponding connecting elements 60, 62, 64, 66, 68, onto the panel 46, respectively onto the respective connection elements 48, allows releasing the connection elements 48 from the corresponding connecting elements 60, 62, 64, 66, 68. The disassembly force is herein greater than a clamping force respectively acting from the connecting elements 60, 62, 64, 66, 68 onto the connection elements 48. In disassembly the connection elements 48 slide out of the corresponding connecting elements 60, 62, 64, 66, 68 in the disassembly direction, wherein neither the connection elements 48 nor the connecting elements 60, 62, 64, 66, 68 nor the aircraft module 44 are damaged or destroyed. A mounting of the panel 46 to the aircraft module 44 is possible with the same connecting elements 60, 62, 64, 66, 68 and connection elements 48.

The aircraft module covering device comprises further aircraft modules 86, 88, 90. In the following the aircraft modules 86, 88, 90 will not be described in detail. The one aircraft module 88 is herein embodied as a handrail. The aircraft module 88 is embodied as a bumper strip. The aircraft module 90 is embodied as a lateral cover. The aircraft modules 86, 88, 90 are herein respectively covered by a panel (not described in detail) in the same way as the aircraft modules 10, 44 described above. A connection of the respective panel to the aircraft modules 86, 88, 90 is established correspondingly to the connection of the panels 12, 46 to the aircraft modules 10, 44 described above.

### REFERENCE NUMERALS

10 aircraft module
12 panel
14 flight passenger seat module
16 flight passenger seat
18 connection element
20 connection element
22 connection element
24 connection element
26 visible side
28 underside
30 recess
32 connecting element
34 support element
36 support element
38 upper side
40 hook element
42 hook element
44 aircraft module
46 panel
48 connection element
50 recess
52 recess
54 recess
56 recess
58 recess
60 connecting element
62 connecting element
64 connecting element
66 connecting element
68 connecting element
70 hook element
72 hook element
74 hook element
76 hook element
78 fiber-composite plate
80 stiffening structure
82 reinforcement zone
84 reinforcement zone
86 aircraft module
88 aircraft module
90 aircraft module

1. An aircraft module covering device with at least one aircraft module and with at least one panel which is configured for covering the aircraft module and is for this purpose fixedly connected to the aircraft module to at least partly cover the aircraft module in a mounted state, wherein the panel is configured to be connected to the aircraft module via at least one form-fit connection and comprises for this purpose at least one connection element, which is fixedly arranged on an underside of the panel.

2. The aircraft module covering device according to claim 1, wherein the at least one connection element on the underside of the panel is implemented as an extension.

3. The aircraft module covering device according to claim 1, wherein the panel is configured to be connected to the aircraft module in such a way that it is non-destructively releasable.

4. The aircraft module covering device according to claim 1 wherein the at least one connection element on the underside of the panel is implemented as a flat gudgeon.

5. The aircraft module covering device according to claim 1, wherein the at least one connection element is connected to the panel by substance-to-substance bond.

6. The aircraft module covering device according to claim 1, wherein the at least one connection element is connected to the panel via an adhesive bond.

7. The aircraft module covering device according to claim 1, wherein the panel is embodied as a deep-drawn plastic component.

8. The aircraft module covering device according to claim 1, further comprising at least one connecting element, which is configured for captively connecting the at least one connection element of the panel to the aircraft module in at least one operating state.

9. The aircraft module covering device according to claim 8, wherein, for captively connecting the connection element to the aircraft module, the at least one connecting element is implemented separately.

10. The aircraft module covering device at least according to claim 8, wherein the aircraft module comprises at least one recess in which the at least one connecting element, which is embodied separately, engages in a mounted state.

11. The aircraft module covering device at least according to claim 8, wherein the connecting element has a U-shaped basis shape, implementing at least two inward-oriented hook elements.

12. The aircraft module covering device at least according to claim 8, wherein the connecting element is configured to be coupled with an aircraft module that is made of sheet metal.

13. The aircraft module covering device at least according to claim 8, wherein the connecting element is configured to be coupled with an aircraft module that is made of a fiber-composite material.

14. A panel according to claim 1.
